(19) United States
(12) Patent Application Publication
(10) Pub. No.: US 2025/0167507 A1
(43) Pub. Date: May 22, 2025

(54) OPTICAL DEVICE CAPABLE OF HAVING PULSE WIDTH REDUCED AND ADJUSTED AND LASER RESONATOR INCLUDING THE SAME

(71) Applicant: Electronics and Telecommunications Research Institute, Daejeon (KR)

(72) Inventors: Won Bae CHO, Daejeon (KR); Suntak PARK, Daejeon (KR); Hyung Cheol SHIN, Daejeon (KR)

(73) Assignee: Electronics and Telecommunications Research Institute, Daejeon (KR)

(21) Appl. No.: 18/944,765

(22) Filed: Nov. 12, 2024

(30) Foreign Application Priority Data
Nov. 20, 2023 (KR) 10-2023-0160580
Oct. 2, 2024 (KR) 10-2024-0134237

(51) Int. Cl. H01S 3/108; H01S 3/00; H01S 3/06; H01S 3/081

(52) U.S. Cl. CPC H01S 3/108; H01S 3/0071; H01S 3/0602; H01S 3/0623; H01S 3/0816

(57) ABSTRACT

Disclosed are an optical device capable of having pulse width reduced and adjusted and a laser resonator including the same. The laser resonator including an optical system that forms a first focusing regime and laser crystals disposed in the first focusing regime includes one or more lenses that form a second focusing regime, and an optical device disposed within the second focusing regime and having high non-linearity. A material having a saturated absorption characteristic may be coated on at least one side of the optical device.

### CROSS-REFERENCE TO RELATED APPLICATION(S)

This application claims priority to and the benefit under 35 USC § 119 of Korean Patent Application 'No. 10-2023-0160580 filed on Nov. 20, 2023, and 'No. 10-2024-0134237 filed on Oct. 2, 2024, in the Korean Intellectual Property Office, the entire disclosures of which is incorporated herein by reference for all purposes.

### BACKGROUND

### 1. Technical Field

The present disclosure relates to an optical device capable of having pulse width reduced and adjusted and a laser resonator including the same.

### 2. Related Art

A laser is divided into a continuous laser that continuously emits beams and a pulse type laser that emits beams at temporal intervals. If the continuous laser and the pulse type laser have the same laser output characteristics, the pulse type laser has stronger energy than the continuous laser for a limited time. In the case of peak power that is obtained by dividing energy of a pulse by the time width of the pulse, in general, the pulse type laser has at least several hundreds of pieces of peak power than the continuous laser. Accordingly, the pulse type laser is widely used regardless of medical and industry fields.

In the case of the pulse type laser, lasers that are currently widely used are named and divided into a nanosecond (10-9 second) laser, a picosecond (10-12 second) laser, and a femtosecond (10-15 second) laser on the basis of the time width of a pulse. In fields such as precision processing or spectroscopy, a case in which the femtosecond laser is used is greatly increased.

Techniques that are most widely used globally in order to develop the femtosecond laser so far are passive mode-locking techniques. Among the passive mode-locking techniques, a Kerr-lens mode-locking technique that uses the non-linearity of laser crystals has been most used. However, in the case of the Kerr-lens mode-locking technique, a laser operates at a very limited location of a stable regime in which a laser operates. Furthermore, the Kerr-lens mode-locking technique has a very high development degree of difficulty because positive dispersion that occurs within a laser resonator has to be very precisely compensated.

In order to overcome such a problem, a saturated absorber technique, among the passive mode-locking techniques, is newly used a lot. If a saturated absorber is used, a femtosecond laser can be relatively easily developed because a short pulse can be generated by inducing mode locking even in a laser-stable regime having a wide range.

A saturated absorber that is most successful so far is a semiconducting saturable absorber mirror (so-called SESAM) that is fabricated through a semiconductor process technique. However, the SESAM has disadvantages in that a fabrication process is complicated because the SESAM is fabricated by a semiconductor process and thus the SESAM has a high price.

In order to overcome the disadvantages, recently, new forms of saturated absorbers based on a one-dimensional (e.g., single walled carbon nano tube) or two-dimensional (e.g., graphene, graphene oxide, TMDCs) material are a lot developed. If such saturated absorbers are used, an operation of a laser automatically emitting a pulse can be implemented. Accordingly, a lot of research is carried out on the saturated absorbers.

Although the pulse type laser is easily developed by using the saturated absorber, the width of a pulse that is emitted is approximately determined depending on conditions (e.g., a length, a figure of merits, a dispersion characteristic of a material, and the non-linearity of a material) of laser crystals and optical characteristics of optical parts that constitute a laser resonator.

In order to generate an ultra-short pulse having a femtosecond level in a process of developing a pulse laser, in general, a lot of time and costs are required to optimize conditions, such as laser crystals that are gain media, mirrors that are used to construct a laser, and additional optical parts (e.g., a prism or a chirp mirror) for adjusting a dispersion characteristic. However, in most of the lasers except some lasers including a Ti:sapphire laser for which optimization conditions have been well known, it is not easy to obtain a short pulse having a 100 femtosecond level. Furthermore, the width of a pulse that is generated by a laser is determined by the conditions of a laser resonator that is constructed. Most optical parts are each operated by being tied with each optical mount. Accordingly, it is not easy to replace the optical part, and a lot of time and efforts are required until mode-locking conditions are found again because optical alignment is severely twisted in the replacement process. Only materials that have a low refractive index of a substrate and that rarely affect operating characteristics of a laser resonator, such as quartz and CaF₂, have been used for a transmissive saturated absorber so far.

### SUMMARY

Various embodiments are directed to providing an optical device that enables a laser to automatically oscillate and also enables the emission of a shorter pulse compared to the existing optical device, and a laser resonator including the same.

In an embodiment, a laser resonator including an optical system that forms a first focusing regime and laser crystals disposed in the first focusing regime further includes one or more lenses that form a second focusing regime, and an optical device disposed within the second focusing regime and having high non-linearity.

In an embodiment, a material having a saturated absorption characteristic may be coated on at least one side of the optical device.

In an embodiment, both sides of the optical device may be subjected to anti-reflection coating. In an embodiment, a material having a saturated absorption characteristic may be coated on the anti-reflection coating of one of the both sides subjected to the anti-reflection coating.

In an embodiment, the material having the saturated absorption characteristic may be any one of a nano tube, graphene, and TMDC.

In an embodiment, the optical device having high non-linearity is a device made of a material that has a non-linear refractive index that is at least five times a non-linear refractive index of CaF₂ and that has linear transmissivity of 50% or more in a wavelength band in which a laser operates.

In an embodiment, the optical device having high non-linearity may be a ZnSe or ZnS substrate.

In an embodiment, the optical device may be mounted near a focus in the second focusing regime, and may be mounted at a Brewster angle in which a refractive index of a material is considered or at an angle that is perpendicular to a laser beam.

The laser resonator may have various structures, such as a Z-cavity structure, an X-cavity structure, and an L-cavity structure.

In an embodiment, there is provided an optical device in which a material having a saturated absorption characteristic is coated on at least one side of a substrate having high non-linearity. The optical device is disposed in an additional focusing regime of a laser resonator.

In an embodiment, both sides of the optical device may be subjected to anti-reflection coating. In an embodiment, a material having a saturated absorption characteristic may be coated on the anti-reflection coating of one of the both sides subjected to the anti-reflection coating.

The material having the saturated absorption characteristic may be any one of a nano tube, graphene, and TMDC.

In an embodiment, the substrate having high non-linearity is made of a material that has a non-linear refractive index that is at least five times a non-linear refractive index of CaF₂ and that has linear transmissivity of 50% or more in a wavelength band in which a laser operates.

In an embodiment, the substrate having high non-linearity is a ZnSe or ZnS substrate.

According to the embodiments of the present disclosure, the laser resonator can be induced to have a spectrum having a long pulse that is generated due to a reinforced non-linear magnetic phase modulation characteristic not a common dispersion compensation object because the optical device having high non-linearity is inserted into the laser resonator. As a result, a short pulse generation effect that is induced by a reinforced non-linear phenomenon can be obtained because a pulse having a wide spectrum has a shorter pulse time width through a time-bandwidth product calculation method.

Although the transparent substrate having high non-linearity is inserted into the focusing regime that is additionally formed within the laser resonator, a phenomenon in which the width of a pulse is reduced due to an increased magnetic phase modulation phenomenon can be seen. If the transparent substrate having the high non-linear characteristic is made slim, a long pulse can be emitted through a relatively weak magnetic phase modulation phenomenon attributable to reduced non-linearity. If the transparent substrate having the high non-linear characteristic is made thick, a short pulse can be emitted through a relatively reinforced magnetic phase modulation phenomenon attributable to increased non-linearity.

Furthermore, an optical loss attributable to an additional optical system can be minimized and the time width of a pulse that is generated by inducing and adjusting an additional magnetic phase modulation phenomenon can also be adjusted because the transparent substrate is inserted into the laser resonator. Furthermore, an optical switching operation can also be implemented because the material having a saturated absorption characteristic is applied or transferred on the optical device having high non-linearity. Accordingly, there are advantages in that a pulse having a width shorter than the time width of a pulse which may be basically emitted by a laser can be emitted and a laser can automatically emit a pulse because the material having a saturated absorption characteristic is mounted within the laser resonator.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1A illustrates a first embodiment of a solid laser resonator in which an additional focusing regime is formed in a conventional laser resonator and an optical device having high non-linearity is disposed in the additional focusing regime.

FIG. 1B illustrates a second embodiment of a solid laser resonator in which an additional focusing regime is formed in a conventional laser resonator and an optical device having high non-linearity is disposed in the additional focusing regime.

FIG. 1C illustrates a third embodiment of a solid laser resonator in which an additional focusing regime is formed in a conventional laser resonator and an optical device having high non-linearity is disposed in the additional focusing regime.

FIG. 2 illustrates experimentally measured results of the characteristics of pulses that are emitted by lasers when CaF₂ was disposed in an additional focusing regime and ZnSe having high non-linearity and having the same thickness as CaF₂ was disposed in the additional focusing regime in the first embodiment.

FIG. 3A and FIG. 3B are diagrams schematically illustrating information of the experimental results in FIG. 2.

FIG. 4A, FIG. 4B, and FIG. 4C are diagrams illustrating that the width of a pulse that is generated is relatively changed when the thickness of a material having a high refractive index is changed.

FIG. 5A, FIG. 5B, FIG. 5C, and FIG. 5D illustrate various forms of an optical device which may be mounted in the additional focusing regime.

FIG. 6A and FIG. 6B are optical transmittance and photographs of a high-quality monolayer graphene saturated absorber (G-SA). FIG. 6A is a case in which graphene was transferred on a CaF₂ substrate, and FIG. 6B is a case in which graphene was transferred on a ZnSe substrate.

FIG. 7A and FIG. 7B illustrate dispersion compensation within a cavity. FIG. 7A illustrates a theoretical GDD spectrum of a Cr:ZnS having a thickness of 5.05 mm, an output coupler OC, a concave mirror, a ZnSe plate (ZnSe) having a thickness of 2 mm, and a CaF₂ plate (CaF₂) having a thickness of 2 mm, and FIG. 7B illustrates a round-trip GDD spectrum of a Cr:ZnS resonator using a graphene saturated absorber based on CaF₂ (G-CaF₂) and ZnSe (G-ZnSe).

FIG. 8A illustrates laser output power as a function of an incident pump output, FIG. 8B illustrates a radio frequency (RF) spectrum of a fundamental beat note in 234.8 MHz and a 1-GHz width span RF spectrum (inserted figure), FIG. 8C illustrates an optical spectrum, and FIG. 8D illustrates an intensity autocorrelation trace using sech² adaptation, in a passive mode-locking Cr:ZnS laser using graphene on the CaF₂ substrate.

FIG. 9A illustrates laser output power as a function of an incident pump output, FIG. 9B illustrates an RF spectrum of a fundamental beat note in 234.01 MHz and a 1-GHz width span RF spectrum (inserted figure), FIG. 9C illustrates an optical spectrum, and FIG. 9D illustrates an intensity autocorrelation trace using sech² adaptation, in a passive mode-locking Cr:ZnS laser using graphene on a ZnSe substrate.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

In an embodiment of the present disclosure, an optical device having high non-linearity is mounted within a solid laser resonator or an optical fiber laser resonator. The optical device may be disposed in an additional focusing regime of a device in order to transmit high power to the device. In order to construct the additional focusing regime, one or more lenses or reflective concave mirrors may be disposed in the device. The focusing regime of each of the lenses or reflective concave mirrors preferably has a range of 10 to 200 mm, but may be different depending on resonator conditions.

The optical device is mounted near a focus in the additional focusing regime, and may be mounted at the Brewster angle in which the refractive index of a material of the optical device has been considered or at an angle that is perpendicular to a laser beam.

The material of the optical device is preferably a material that has a non-linear characteristic in which a non-linear refractive index is at least five times or higher than the non-linear refractive index (n2=1 to 2×10⁻²⁰ m²/W) of quartz or CaF₂ that is conventionally used and that has linear transmissivity of 50% or more in a wavelength band in which a laser operates. In an embodiment, ZnSe or ZnS may be used as the material of the optical device. In an embodiment, a non-linear material, such as a nano tube, graphene, and TMDC having various saturated absorption characteristics, may be applied or transferred on the substrate of the optical device.

In an embodiment, the substrate of the optical device may have a form in which anti-reflection coating processing has been performed on the substrate in a laser operation wavelength band. For example, the substrate of the optical device may be fabricated in the form of a substrate-saturated absorber material-anti-reflection coating structure or a substrate-anti-reflection coating-saturated absorber material structure.

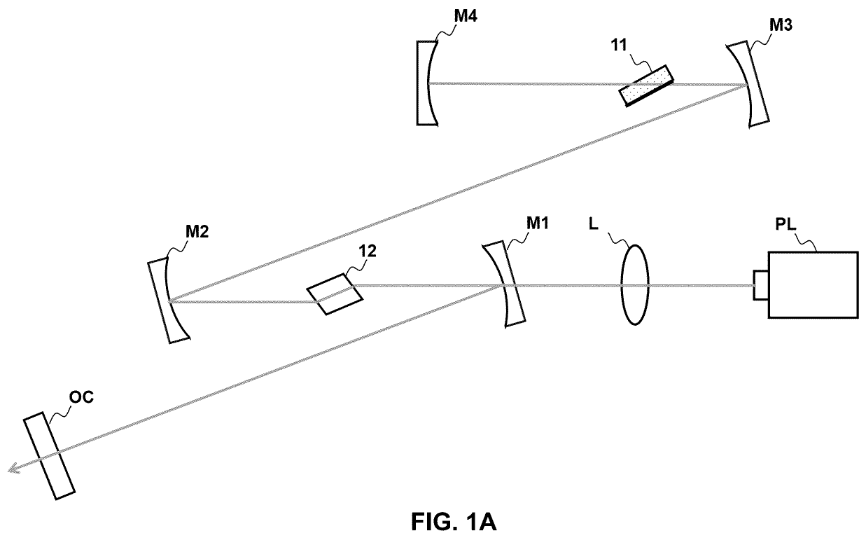

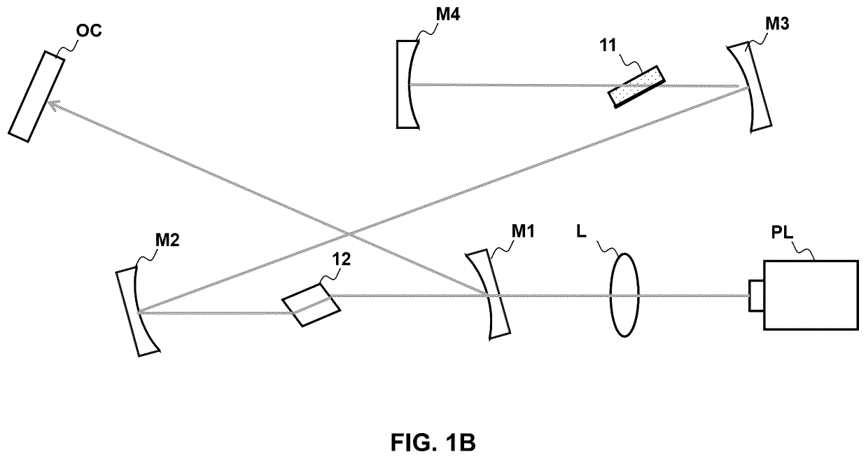

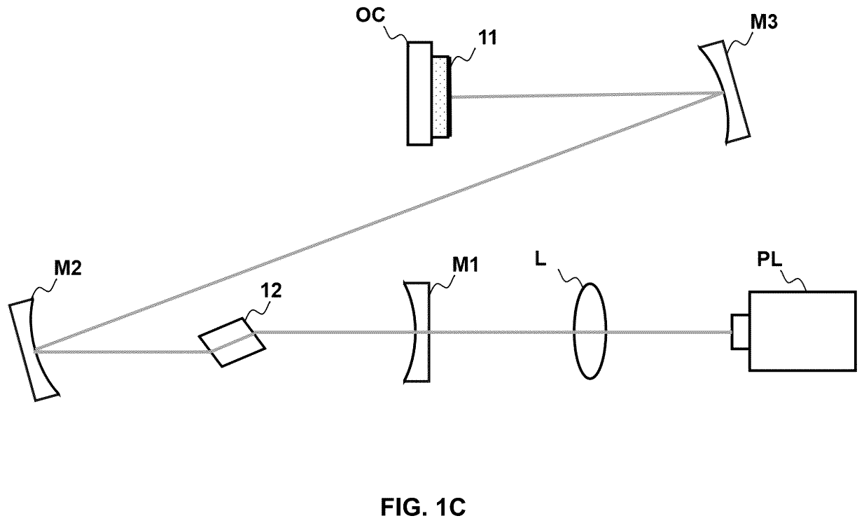

FIGS. 1A to 1C illustrate some embodiments of a solid laser resonator in which an additional focusing regime is formed in a conventional laser resonator and an optical device having high non-linearity is disposed in the additional focusing regime. In FIGS. 1A to 1C, the location of an output coupler OC according to each resonator form is merely an example, and the output coupler OC may be installed at the location of another mirror.

FIG. 1A illustrates an embodiment of a Z-cavity structure including an additional focusing regime. A laser resonator of FIG. 1A includes a pump laser PL, a pump focusing lens L, a first reflective concave mirror M1 and a second reflective concave mirror M2 for forming a first focusing regime, laser crystals 12 disposed between the first reflective concave mirror M1 and the second reflective concave mirror M2, a third reflective concave mirror M3 and a fourth reflective concave mirror M4 for forming an additional focusing regime, that is, a second focusing regime, an optical device 11 disposed in the second focusing regime between the third reflective concave mirror M3 and the fourth reflective concave mirror M4, and an output coupler OC for outputting a laser. It is preferred that the optical device 11 is mounted at the Brewster angle because the optical device has a high refractive index due to high non-linearity and thus a reflection loss thereof is great. However, the optical device 11 may be disposed at an angle that is perpendicular to a direction in which a laser is incident on the optical device 11 depending on conditions for the laser resonator.

FIG. 1B illustrates an embodiment of an X-cavity structure including an additional focusing regime. A laser resonator of FIG. 1B includes a pump laser PL, a pump focusing lens L, a first reflective concave mirror M1 and a second reflective concave mirror M2 for forming a first focusing regime, laser crystals 12 disposed between the first reflective concave mirror M1 and the second reflective concave mirror M2, a third reflective concave mirror M3 and a fourth reflective concave mirror M4 for forming a second focusing regime, an optical device 11 disposed in the second focusing regime between the third reflective concave mirror M3 and the fourth reflective concave mirror M4, and an output coupler OC for outputting a laser. It is preferred that the optical device 11 is mounted at the Brewster angle because the optical device has a high refractive index due to high non-linearity and thus a reflection loss thereof is great. However, the optical device 11 may be disposed at an angle that is perpendicular to a direction in which a laser is incident on the optical device 11 depending on conditions for the laser resonator.

FIG. 1C illustrates an embodiment of an L-cavity structure including an additional focusing regime. In the embodiment of FIG. 1C, a focusing regime is formed by using one reflective concave mirror. A laser resonator of FIG. 1C includes a pump laser PL, a pump focusing lens L, a first reflective concave mirror M1 and a second reflective concave mirror M2 for forming a first focusing regime, laser crystals 12 disposed between the first reflective concave mirror M1 and the second reflective concave mirror M2, a third reflective concave mirror M3 for forming a second focusing regime, an output coupler OC for outputting a laser that is reflected by the third reflective concave mirror M3, and an optical device 11 disposed in the output coupler OC. In the embodiment of FIG. 1C, unlike in the embodiments of FIGS. 1A and 1B, the additional focusing regime is formed by using only one concave mirror M3. It is preferred that the optical device 11 is mounted at the Brewster angle because the optical device has a high refractive index due to high non-linearity and thus a reflection loss thereof is great. However, the optical device 11 may be disposed at an angle that is perpendicular to a direction in which a laser is incident on the optical device 11 depending on conditions for the laser resonator.

Cr:ZnS crystals that are commonly used may be used as the laser crystals 12. It is preferred that the material of the optical device 11 is preferably a material that has a non-linear characteristic in which a non-linear refractive index is at least five times or higher than the non-linear refractive index (n2=1 to 2×10⁻²⁰ m²/W) of quartz or CaF₂ that is conventionally used and that has linear transmissivity of 50% or more in a wavelength band in which a laser operates. In an embodiment, ZnSe or ZnS may be used as the material of the optical device 11. In an embodiment, a non-linear material, such as a nano tube, graphene, and TMDC having various saturated absorption characteristics, may be applied or transferred on the substrate of the optical device.

Each additional focusing regime (i.e., the second focusing regime) has a structure for maximizing the characteristics of the material having high non-linearity. An optical fiber laser may be constructed by coating and attaching a material having high non-linearity within an optical fiber resonator, or may be constructed so that a beam of an optical fiber laser resonator is taken out to the outside of an optical fiber and enters the optical fiber again after passing through an additional focusing regime using two lenses.

It is preferred that the focal length of each of a lens and a concave mirror that are used to construct an additional focusing regime is at a 10 to 200 mm level, but such numerical values may be different depending on conditions for a resonator in addition to the presented range.

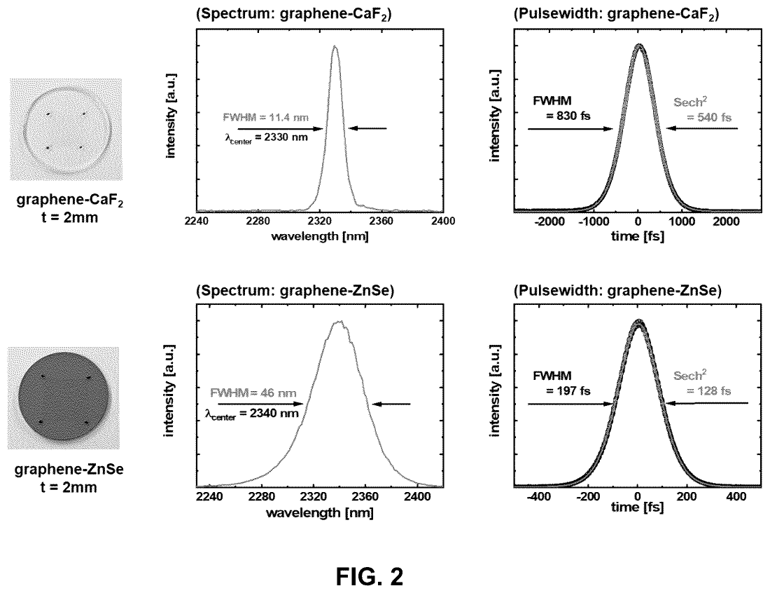

FIG. 2 illustrates experimentally measured results of characteristics of a pulse that is emitted by a laser when graphene, that is, a saturated absorption material, was applied on a CaF₂ substrate (having a thickness of 2 mm) having low non-linearity in the location of the optical device 11 and then disposed in a focusing regime and when CaF₂ was changed into ZnSe having high non-linearity and the same thickness as CaF₂ as the material of the substrate, when a Cr:ZnS laser, that is, a solid laser having a 2.3 μm mid-infrared band, had the structure of FIG. 1A.

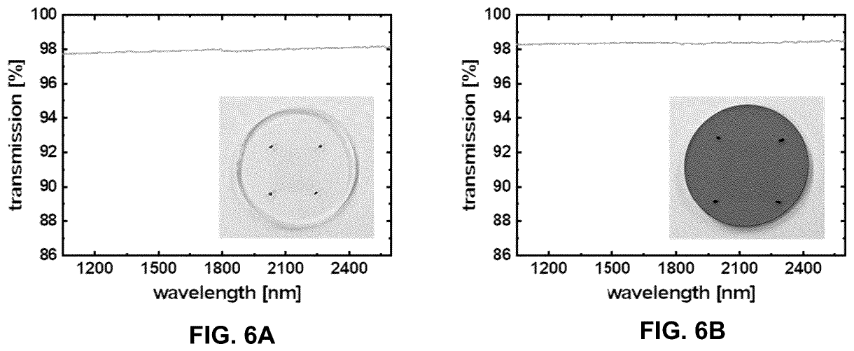

Actual experimental results revealed that under conditions in which the output of the laser was the same and a laser optical part was completely the same, a spectrum when graphene was transferred on the ZnSe material, that is, a material having non-linearity that was about 100 times higher than that of CaF₂, and then inserted into the additional focusing regime was 4 times higher than a spectrum when the CaF₂ material was used and a full width half maximum (FWHM) value of a pulse width was reduced by ¼ from 830 fs to 197 fs. It may be seen that a short pulse could be obtained only by forming the additional focusing regime within a laser having a difficulty in emitting a short pulse and inserting a material having a high non-linear characteristic into the additional focusing regime. This means that costs and time that are required to generate a ultra-short pulse in a process of developing a laser can be greatly reduced. Experiment conditions and results of FIG. 2 are described in detail with reference to FIGS. 6A to 9D.

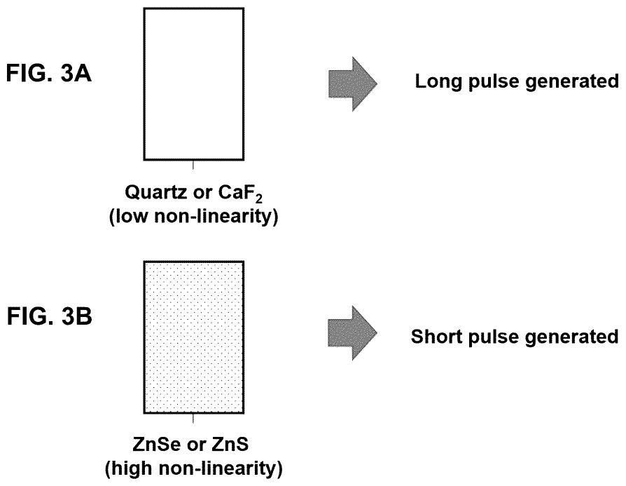

FIG. 3A and FIG. 3B schematically illustrate information of the experimental results of FIG. 2, and schematically illustrates that the size of non-linearity in the same laser conditions is different, but a short pulse is generated when a substrate (or device) having the same thickness is inserted into a resonator and a material having high non-linearity is inserted into the resonator.

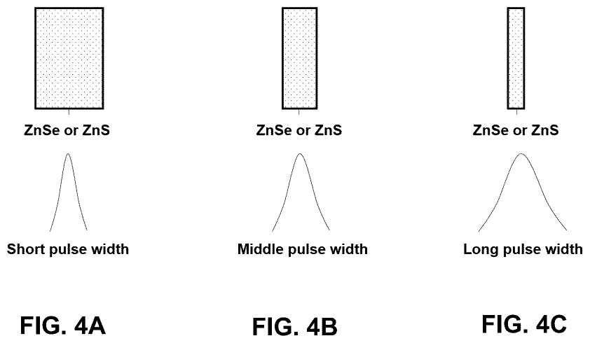

FIG. 4A, FIG. 4B, and FIG. 4C are diagrams illustrating that the width of a pulse generated is also relatively changed because the intensity of a non-linear phenomenon that is induced within a laser resonator may be adjusted when the thickness of a material having a high refractive index is changed. As the thickness of the material is increased, the size of non-linearity that is generated by the laser resonator is increased. Accordingly, the width of the pulse is further reduced.

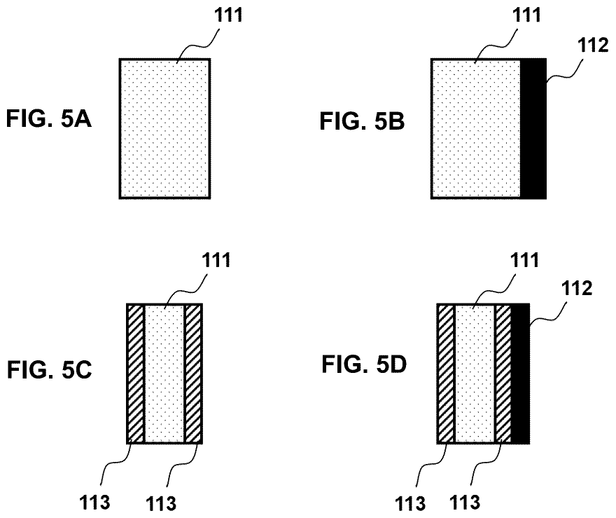

FIG. 5A, FIG. 5B, FIG. 5C, and FIG. 5D illustrate various forms of an optical device which may be mounted in the additional focusing regime. In the case of FIG. 5A, the width of a pulse that is emitted by the laser resonator is reduced only by installing a material 111 having high non-linearity and a form of a substrate in the additional focusing regime at the Brewster angle. It is appropriate that the device (or the substrate) having high non-linearity is mounted at the Brewster angle because the device has a great reflection loss due to a high refractive index, but may be disposed at an angle that is perpendicular to a direction in which a laser is incident on the device depending on conditions for the laser resonator.

FIG. 5B illustrates that a non-linear material 112 having a saturated absorption characteristic is applied or transferred on the substrate 111 illustrated in FIG. 5A. FIG. 5B illustrates a form of an optical switch having a function that self-starts a pulse operation of a laser. FIG. 5B has a form of the most ideal device in which a self-start and the generation of a short pulse are simultaneously implemented in the development of a laser.

FIG. 5C illustrates a form of an optical device in which anti-reflection coatings 113 are performed on both sides of the substrate in order to reduce a reflection loss when the device (or the substrate) illustrated in FIG. 5A is to be disposed in the additional focusing regime perpendicularly to a direction in which a beam proceeds.

FIG. 5D illustrates a form of an optical device in which the non-linear material 112 having a saturated absorption characteristic is transferred or applied to the optical device in FIG. 5C. The non-linear material may be disposed between a high non-linear material, such as ZnSe or ZnS, and the anti-reflection coating surface, which are illustrated in FIG. 5A, FIG. 5B, FIG. 5C, and FIG. 5D, depending on fabrication purposes.

Next, the experiments described with reference to FIG. 2 are described more specifically with reference to FIGS. 6A to 9D. For the experiments of FIG. 2, a monolayer graphene portable absorber was fabricated. First, single-layer graphene that was synthesized on copper (Cu) foil by chemical vapor deposition was rapidly cooled. Thereafter, a support layer of 5 wt % poly (methyl-methacrylate) (PMMA) was spinned and coated on graphene. Thereafter, layers formed of graphene and PMMA by wet-etching the Cu layer with respect to iron chloride (FeCl₃) were moved to a CaF₂ substrate and a zinc selenide (ZnSe) substrate, each one having a diameter of 1 inch and a thickness of 2 mm, respectively. Finally, the PMMA layer was removed by using acetone so that the monolayer graphene-saturated absorber having high quality was left.

As illustrated in FIGS. 6A and 6B, linear optical characteristics of the transmission graphene-saturated absorbers were examined. In the linear transmission curves illustrated in FIGS. 6A and 6B, the monolayer graphene-saturated absorbers deposited on the different substrates show the absorption of about 2% near 2,340 nm. Such a level is a level similar to πα=2.3%, that is, a theoretical value. Photo images of the monolayer graphene—the saturated absorbers used in the present experiments were inserted into FIGS. 6A and 6B. Four dots in each of the CaF₂ and ZnSe substrates illustrate boundary edges of a transferred graphene layer.

For passive mode-locking (ML) of a polycrystalline Cr:ZnS laser using the graphene-saturated absorber, experiment settings for an astigmatically compensated Cr:ZnS laser in a construction, such as that of FIG. 1A, was used. A continuous wave (CW) Er doping fiber laser (λ_{center}=1,550 nm, IPG Photonics in Massachusetts in the United States) that provides a maximum output of 20 W was used as a pumping source. A pump beam was focused on polycrystalline Cr:ZnS crystals through a 100 mm focus lens. The Cr:ZnS crystals having a length of 5.05 mm were supplied from IPG Photonics. A Cr²⁺ concentration of a ZnS host material was about 8.56×10¹⁸ cm⁻³, and the absorption of a small signal in 1,550 nm was about 94.2%.

In order to efficiently remove heat from a gain medium, the Cr:ZnS crystals were mounted on a water cooling type Cu block and stabilized at 15° C. The laser crystals were oriented at the Brewster angle in order to minimize Fresnel reflection losses, and were disposed between the two concave mirrors M1 and M2 having a radius of curve (ROC) of −100 mm. The waist size of a focused pump beam was calculated to be ˜ 57 μm, and the waist size of a resonator beam was estimated to be 65 to 75 μm depending on distances between the two concave mirrors M1 and M2. The sizes of the two beams are comparable and allow efficient energy transfer from the pump to the resonator beam. With the two additional concave mirrors M3 and M4 having an ROC of −75 mm, the second focusing regime was added at the long arm to deliver sufficient energy fluence enough for bleaching the absorption of the saturated absorbers.

A minimum waist size of a beam in the second focusing regime was calculated to be 80-90 μm depending on the position of the concave mirror M4. The graphene-saturated absorbers were placed at the Brewster angle in order to minimize the insertion losses near the focus. The materials of the substrates of the two graphene-saturated absorbers were CaF₂ and ZnSe, and the Brewster angles of the substrates were 54.9° (G-CaF₂) and 67.7° (G-ZnSe) at 2,340 nm, respectively. After exchanging the saturated absorbers with each other, the position of the concave mirror M4 was optimized in the horizontal direction of the optical axis by considering the parallel shift of a beam caused by differences between the Brewster angles of the materials of the substrates. A flat-wedged output coupler (OC) having 15% transmission in the laser wavelength regime was installed in the short arm of the laser cavity. In order to isolate the laser from environmental effects, such as an airflow and humidity, the Cr:ZnS laser was enclosed with acrylic blocks, but was not purged with nitrogen gases in order to reduce humidity.

All of the laser mirrors in the cavity are manufactured by an ion beam sputtering (IBS) coating process and have the trait of group delay dispersion (GDD)-reflection optimized (Layertec GmbH, Mellingen, Germany). However, the mirrors are not optimized for higher-order dispersion. The GDD of 15% OC is nearly 0 fs² at the laser spectral ranges, but the focusing mirrors M1 to M4 provide negative GDD between 2,100 nm and 2,600 nm.

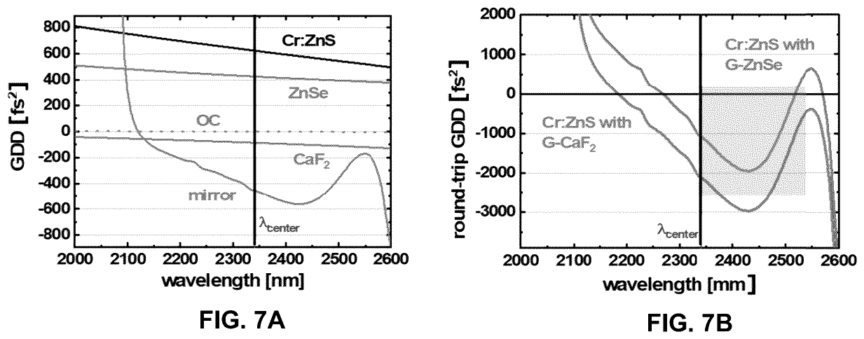

Therefore, the opposite sign GDD from the Cr:ZnS laser crystals and ZnSe substrate of the saturated absorber was sufficiently compensated by using four focusing mirrors. However, the four focusing mirrors were not designed like a typical chirped mirror having homogeneous GDD at specific spectral ranges. The four focusing mirrors introduced inhomogeneous and relatively strong negative GDD near 2,430 nm (GDD=−450 fs² per bounce at a central wavelength of 2,340 nm). FIG. 7(a) illustrates the wavelength dependence of GDD for different optical components within the laser cavity, such as the laser crystals, different substrates of the saturated absorbers, an OC, and a GDD-optimized mirror. Vertical solid lines in FIG. 7 indicate the central wavelength of the passively mode-locked Cr:ZnS laser using the graphene-saturated absorbers. As illustrated in FIG. 7(b), the net round-trip GDD of the laser cavity was calculated to be −2,100 fs² and −1,070 fs² at 2,340 nm for the CaF₂ and ZnSe substrates of the graphene-saturated absorbers, respectively. Since the net GDD values are similar to the GDD of −1,500 fs², which is adequate to chirp <100 fs pulses, no additional optical components were used in order to minimize the difference between the GDD values. In addition, GDD data illustrated for the mirror in FIG. 7A is simulation data at normal incidence (0 degree). Accordingly, by three mirrors M1 to M3 having a folding angle of 15°, the actual cavity round-trip GDD may differ from the estimated GDD values illustrated in FIG. 7B. In this configuration, passive ML was achieved in a negative dispersion regime by shaking the output coupler.

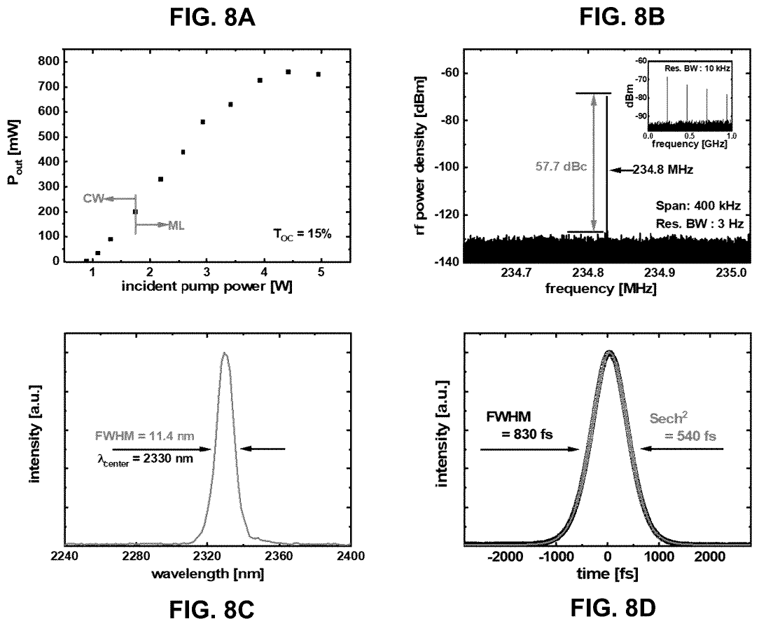

Next, a femtosecond Cr:ZnS laser using graphene on the CaF₂ substrate is described. First, with graphene on a 2-mm-thick CaF₂ plate (G-CaF₂), a passively mode-locked Cr:ZnS laser was obtained with a small perturbation achieved by moving the output coupler mounted on a linear stage. Average output power versus incident pump power in the femtosecond mode-locked regime was studied as illustrated in FIG. 8A. A solid vertical line illustrates an ML threshold, that is, 200 mW output at 1.75 W incident pump power. Maximum output power of 760 mW was achieved for a pump level of 4.4 W. The mode-locked operation was sustained for several hours in a whole power range above the ML threshold. In addition, there were no symptoms of degradation in the saturated absorber due to damage to the graphene layer. Higher average power was readily obtained with increasing pump power, but the laser became unstable, and the emerging multiple-pulsing tendency and strong CW components could not be suppressed easily.

The radio-frequency (RF) spectrum of the femtosecond Cr:ZnS laser was measured in order to verify a stable mode-locked operation as illustrated in FIG. 8B. A fundamental beat note at 234.8 MHz exhibited an extinction ratio of 57.7 dB or more above the carrier (dBc) as the results of measurement at a resolution bandwidth of 3 Hz within a 400 kHz span. An insert in FIG. 8B illustrates 1 GHz wide bandwidth RF measurement. Two RF spectra that were measured at different spans apparently exhibit a stable and clean CW mode-locked operation without an unwanted laser operation, such as Q-switching instability and multiple-pulsing.

FIGS. 8C and 8D illustrate a laser spectrum and an intensity autocorrelation trace that were recorded at the output power around about 630 mW. An output spectrum and a pulse width were simultaneously measured by the WaveScan USB MIR (A.P.E GmbH, Berlin, Germany) and the PulseCheck USB MIR (A.P.E GmbH), respectively. The center of the spectrum was 2,330 nm, and the spectrum had a spectral bandwidth of 11.4 nm. The autocorrelation trace was fitted well by assuming a sech²-shaped pulse, and its pulse width (full width at half maximum (FWHM)) was 540 fs. A corresponding time-bandwidth product was 0.34, which is close to a theoretical value 0.315 for a transform-limited sech² pulse.

When comparing other laser cavities with similar round-trip GDD values, the Cr:ZnS laser produced relatively long pulses despite sufficient negative net GDD of −2,000 fs² at the central wavelength regime. It is considered that a proper explanation for generating long femtosecond pulses is inhomogeneous GDD compensation over the laser spectral range rather than insufficient dispersion compensation of the laser resonator and non-optimized parameters of the gain element. Accordingly, it is expected to achieve an even shorter pulse width by additional optimization to make the dispersion more flat in the negative GDD regime.

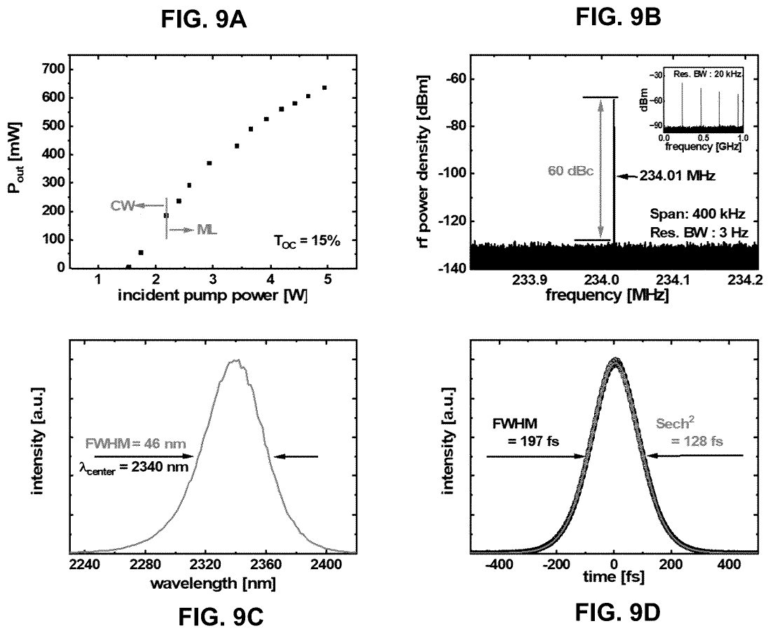

Next, a femtosecond Cr:ZnS laser using graphene on the ZnSe substrate is described. For a comparison in this laser cavity, the 2-mm-thick G-CaF₂ was replaced with graphene on the ZnSe base plate (G-ZnSe) having the same thickness. After the horizontal position of the concave mirror M4 was optimized, passive ML in the Cr:ZnS laser was also achieved. FIG. 9A illustrates output properties for the Cr:ZnS laser using the same 15% output couplers. A vertical line in FIG. 9A indicates an ML threshold, that is, a 185 mW output at 2.19 W pump power. The laser produced high ML output power of 635 mW at incident pump power of 4.95 W.

In this case, relatively higher ML thresholds were attributed to increased cavity losses that were caused by the ZnSe substrate, which had relatively lower transmittance than the CaF₂ substrate. The mode-locked operation was stable for several hours in the whole ML power range. There was no visible damage on the saturated absorber. At higher ML power levels, unwanted CW components and multiple pulsing interrupted a stable mode-locked operation.

In order to verify the ML stability, RF spectra recorded in different spans are illustrated in FIG. 9B. The first beat note at 234.01 MHz showed a pedestal peak separation of 60 dBc, which was recorded with a resolution bandwidth of 3 Hz within a 400 kHz span. This high signal-to-noise ratio and the 1 GHz span measurement [refer to an inserted figure in FIG. 9B] evidently illustrate a stable single-pulse laser operation without Q-switching instability. The frequency of the fundamental beat note in this figure is comparable with the frequency value in FIG. 8B, which indicates the lengths of the two resonators are almost identical. FIGS. 9C and 9D illustrate an optical spectrum and intensity autocorrelation trace of generated pulses, which were recorded near a maximum output power level of 605 mW. A spectral bandwidth (full width at half maximum (FWHM)) of the pulses was measured to be 46 nm centered at 2,340 nm. Assuming a sech²-shaped pulse, the autocorrelation trace shows a pulse width of 128 fs (FWHM) having a corresponding time-bandwidth product of 0.322. This is close to the theoretically expected value of 0.315 for the transform-limited sech² pulse. A slight asymmetrical spectrum illustrated in FIG. 9C was observed because of intra-cavity atmospheric absorption of above 2,400 nm, which can be moderated by purging the cavity with a nitrogen gas.

As described above, in the condition of inhomogeneous round-trip GDD compensation, shorter pulses were achieved by only replacing the substrate of the graphene-saturated absorbers from CaF₂ to ZnSe. The high nonlinearity of the ZnSe substrate led to an expansion in the spectral bandwidth of the oscillating pulse as a result of the enhanced self-phase modulation effect in the substrate of the graphene-saturated absorber. Despite negative net cavity GDD of −1,000 fs² at the central wavelength range, the Cr:ZnS laser did not generate sub-100-fs pulses, compared with other laser cavities with similar round-trip GDD values around −1,500 fs². Based on these results, it is estimated that inhomogeneous GDD compensation may be a dominant factor in achieving a pulse of more than 100 fs. Based on the results, it is expected that optimizing the intra-cavity net GDD for a flat GDD profile over a broad spectral range will shorten the pulse duration further.

In the experiments, passively mode-locked 2.3 μm Cr:ZnS laser with monolayer graphene coated on different substrates, CaF₂ and ZnSe were demonstrated. The mode-locked Cr:ZnS laser with on CaF₂ coated with graphene generated relatively long pulses of 540 fs near 2,330 nm. In a stable single-pulse operation, output power up to 760 mW at 234.8 MHz repetition rates was achieved. Uneven round-trip GDD compensation would be a dominant cause for the generation of a long pulse in the negative dispersion cavity. For a direct comparison within the same laser cavity, the G-CaF₂ was replaced with the G-ZnSe, and only the position of the end mirror was adjusted in the horizontal direction of the optical axis. Due to the high nonlinearity of the ZnSe plate of the saturated absorber, the femtosecond Cr:ZnS laser generates shorter transform-limited pulses with duration of ˜130 fs at 2,340 nm in a stable single-pulse regime. Average power up to 635 mW at the repetition rate of 234 MHz was obtained. If the net cavity GDD for a flat GDD profile is further optimized, it is expected to achieve an even shorter pulse width. This represents the first endeavor to attain shorter pulse duration from a polycrystalline Cr:ZnS laser by using graphene deposited on a high nonlinearity ZnSe substrate. Ultra-short pulses having ˜130 fs pulse duration in the polycrystalline Cr:ZnS lasers can be generated even without precise control of intra-cavity net GDD. The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

### DESCRIPTION OF REFERENCE NUMERALS

PL: pump laser 11: optical device
12: laser crystals L: pump focusing lens
M1: first reflective concave mirror
M2: second reflective concave mirror
M3: third reflective concave mirror
M4: fourth reflective concave mirror
OC: output coupler

What is claimed is:

1. A laser resonator comprising an optical system that forms a first focusing regime and laser crystals disposed in the first focusing regime, the laser resonator comprising:
one or more lenses that form a second focusing regime; and
an optical device disposed within the second focusing regime and having high non-linearity.

2. The laser resonator of claim 1, wherein a material having a saturated absorption characteristic is coated on at least one side of the optical device.

3. The laser resonator of claim 2, wherein the material having the saturated absorption characteristic is any one of a nano tube, graphene, and TMDC.

4. The laser resonator of claim 1, wherein both sides of the optical device are subjected to anti-reflection coating.

5. The laser resonator of claim 4, wherein a material having a saturated absorption characteristic is coated on the anti-reflection coating of one of the both sides subjected to the anti-reflection coating.

6. The laser resonator of claim 5, wherein the material having the saturated absorption characteristic is any one of a nano tube, graphene, and TMDC.

7. The laser resonator of claim 1, wherein the optical device having high non-linearity is a device made of a material that has a non-linear refractive index that is at least five times a non-linear refractive index of CaF₂ and that has linear transmissivity of 50% or more in a wavelength band in which a laser operates.

8. The laser resonator of claim 1, wherein the optical device having high non-linearity is a ZnSe or ZnS substrate.

9. The laser resonator of claim 1, wherein the optical device is mounted near a focus in the second focusing regime and is mounted at a Brewster angle in which a refractive index of a material is considered or at an angle that is perpendicular to a laser beam.

10. The laser resonator of claim 1, wherein the laser resonator has a Z-cavity structure.

11. The laser resonator of claim 1, wherein the laser resonator has an X-cavity structure.

12. The laser resonator of claim 1, wherein the laser resonator has an L-cavity structure.

13. An optical device in which a material having a saturated absorption characteristic is coated on at least one side of a substrate having high non-linearity.

14. The optical device of claim 13, wherein the material having the saturated absorption characteristic is any one of a nano tube, graphene, and TMDC.

15. The optical device of claim 13, wherein both sides of the optical device are subjected to anti-reflection coating.

16. The optical device of claim 15, wherein a material having a saturated absorption characteristic is coated on the anti-reflection coating of one of the both sides subjected to the anti-reflection coating.

17. The optical device of claim 16, wherein the material having the saturated absorption characteristic is any one of a nano tube, graphene, and TMDC.

18. The optical device of claim 13, wherein the substrate having high non-linearity is made of a material that has a non-linear refractive index that is at least five times a non-linear refractive index of CaF₂ and that has linear transmissivity of 50% or more in a wavelength band in which a laser operates.

19. The optical device of claim 13, wherein the substrate having high non-linearity is a ZnSe or ZnS substrate.

20. The optical device of claim 13, wherein the optical device is disposed in an additional focusing regime of a laser resonator.
